(19) United States
(12) Patent Application Publication
(10) Pub. No.: US 2008/0018824 A1
(43) Pub. Date: Jan. 24, 2008

(54) Liquid Crystal Display Device

(75) Inventor: Noriki Sawa, Tottori-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Seiko Epson Corporation, Tokyo (JP)

(21) Appl. No.: 11/662,098

(22) PCT Filed: Sep. 27, 2005
(86) PCT No.: PCT/JP05/17723

§ 371 Date: Mar. 7, 2007

(30) Foreign Application Priority Data
Sep. 30, 2004 (JP) 2004-286355

(51) Int. Cl. G02F 1/1333

(52) U.S. Cl. 349/58

(57) ABSTRACT

A liquid crystal display device with small outside dimensions and a dustproof structure. The liquid crystal display device has a frame-like frame body (2) in which edge sections (4-7) are formed around an opening (3) and having side sections (9-12), a liquid crystal display body (13) fixed to the frame body (2) so as to be in internal contact with the frame body, a first circuit board (24) provided between the side sections (9-12) and the edge sections (4-7) and connected to the liquid crystal display body (13), a support plate (27) provided substantially orthogonal to a rear section (8) of the frame body (2), and a second circuit board (45) fixed to the support plate (27) and connected to the first circuit board (24).

### TECHNICAL FIELD

The present invention relates to a liquid crystal display device.

### RELATED ART

As known in the art, this type of device is shown in Patent Document 1, for example. According to FIG. 1 in Patent Document 1, a display unit 2 includes a display panel 4, an illumination panel 5 and a frame body 6. A protection cover unit 3 is provided on an upper surface of the display unit 2.

The protective cover unit 3 includes an upper surface frame 9 and a protective cover 10. The upper surface frame 9 is made of a metal having an opening 8 in the center. The protective cover 10 is fixed to the upper surface frame 9 with an adhesive member so as to block the opening 8. The protection cover unit 3 prevents dust from entering the display unit 2.

[Patent Document 1] JP-A-2003-5658

### DISCLOSURE OF THE INVENTION

[Problems to be Solved]

According to FIG. 3 in Patent Document 1, a circuit board driving the display panel 4 can only be placed at a space sandwiched between a leading edge of a rear cover 7 and a leading edge of a covering material 13. However, the width of the above circuit board is generally large (for example, 5 to 10 cm). Therefore, there is a problem of increasing external dimensions (length and width) of a display device 1. In view of such a problem of the related art, the present invention provides a liquid crystal display device with small external dimensions and a dust-proof structure.

[Means to Solve the Problems]

In order to solve the above-mentioned problem, according to claim 1 of the present invention, there is included a frame-like frame body in which edge sections are formed around an opening and having side sections, and a liquid crystal display body fixed to the frame body so as to be in internal contact with the frame body. There is also included a first circuit board provided between the side sections and the edge sections and connected to the liquid crystal display body, and a support plate provided substantially orthogonal to a rear section of the frame body. There is also included a second circuit board fixed to the support plate and connected to the first circuit board.

According to claim 2 of the present invention, there is included an elastic body formed in a frame-like shape having a rear surface side abutting tips of the edge sections and a front surface side abutting the liquid crystal display body. There is also included a sheet fixed to the rear section of the frame body so as to cover the opening.

According to claim 3 of the present invention, the frame body is provided with a pair of recesses to the side section thereof and the support plate is provided with a pair of clips to the side section thereof. The support plate is positioned in a transverse direction and a longitudinal direction to the frame body, by inserting the clips into the respective recesses.

According to claim 4 of the present invention, the frame body is provided with an aperture to the side section and the rear section thereof. One side is fixed to the first circuit board, a middle section is positioned corresponding to the aperture, and the other side is removably connected to a connector provided at the second circuit board.

According to claim 5 of the present invention, the support plate includes a placing surface and a bent section. The placing surface abuts the rear section of the frame body. The bent section abuts the side section of the frame body. The placing surface is fixed to the rear section by a screw.

[Advantages of the Invention]

According to claim 1 of the present invention, there is included a frame-like frame body in which edge sections are formed around an opening and having side sections, a liquid crystal display body fixed to the frame body so as to be in internal contact with the frame body. There is also included a first circuit board provided between the side sections and the edge sections and connected to the liquid crystal display body, and a support plate provided substantially orthogonal to a rear section of the frame body. There is also included a second circuit board fixed to the support plate and connected to the first circuit board. By fixing the second circuit board to the support plate provided substantially orthogonal, and dividing the circuit board into a plurality of pieces, the first circuit board can be reduced in size. As a result, external dimensions (length and width) of a liquid crystal display device having the first circuit board can be reduced in size.

According to claim 2 of the invention, there is included an elastic body formed in a frame-like shape having a rear surface side abutting tips of the edge sections and a front surface side abutting the liquid crystal display body. There is also included a sheet fixed to the rear section of the frame body so as to cover the opening. By providing the elastic body between the tips of the edge sections and the liquid crystal display body and having them sealed, dust can be prevented from entering the liquid crystal display body from outside.

According to claim 3 of the invention, the frame body is provided with a pair of recesses to the side section thereof and the support plate is provided with a pair of clips to the side section thereof. The support plate is positioned in a transverse direction and a longitudinal direction to the frame body, by inserting the clips into the respective recesses. The above structure enables positioning of the support plate in the transverse direction and the longitudinal direction to the frame body, thereby enabling placing of the support plate at a proper position with ease.

According to claim 4 of the invention, the frame body is provided with an aperture to the side section and the rear section thereof. One side is fixed to the first circuit board, a middle section is positioned corresponding to the aperture, and the other side is removably connected to a connector provided at the second circuit board. The above structure enables connection of the first circuit board and the second circuit board with ease.

According to claim 5 of the invention, the support plate includes a placing surface and a bent section. The placing surface abuts the rear section of the frame body. The bent section abuts the side section of the frame body. The placing surface is fixed to the rear section by a screw. The above structure enables fixing of the support plate firmly to the frame body and prevents the support plate from being unsteady (wobbly).

### BRIEF DESCRIPTION OF THE DRAWINGS

FIG. 1 is a perspective view of a liquid crystal display device 1 according to a preferred embodiment of the present invention.

FIG. 2 is a perspective view of the liquid crystal display device 1 when a cover is removed.

FIG. 3 is an exploded perspective view of the liquid crystal display device 1.

FIG. 4 is a sectional view along line A1-A2 in FIG. 1.

FIG. 5 is a sectional view along line B1-B2 in FIG. 1.

FIG. 6 is a detailed view of the portion C in FIG. 2.

### REFERENCE NUMERALS

2: frame body
3: opening
4, 5, 6, 7: edge section
8: rear section
9, 10, 11, 12: side section
13: liquid crystal display body
24: first circuit board
45: second circuit board

### DESCRIPTION OF THE PREFERRED EMBODIMENTS

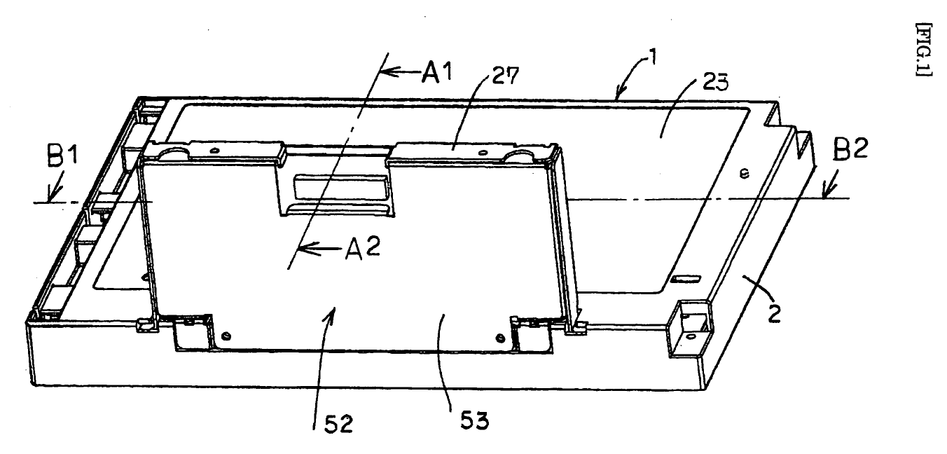

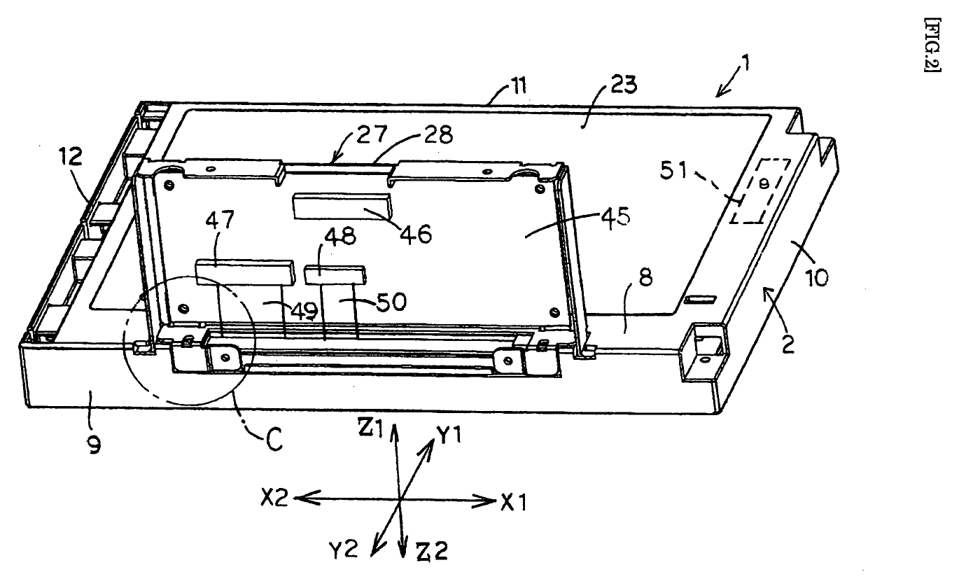

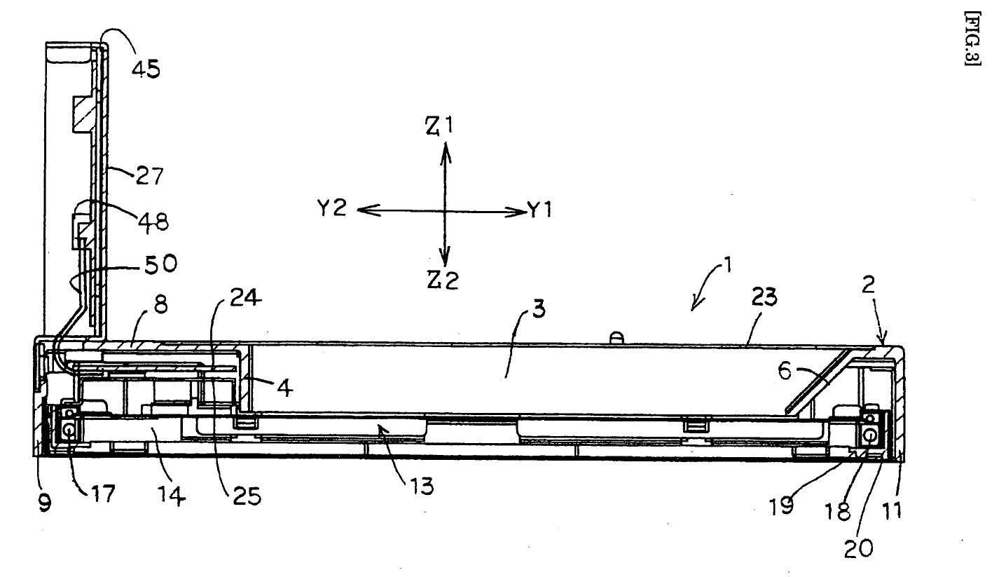

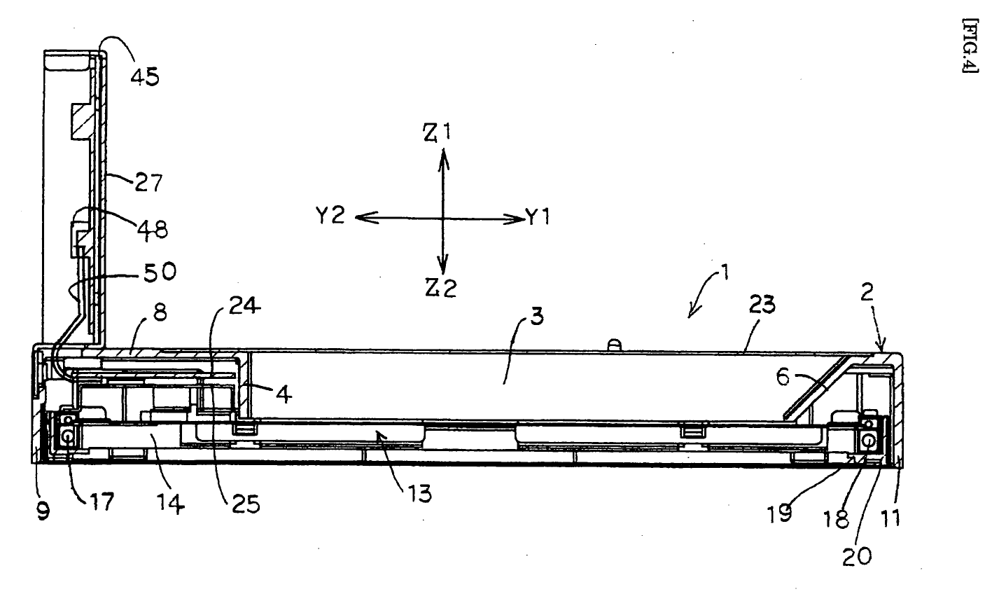

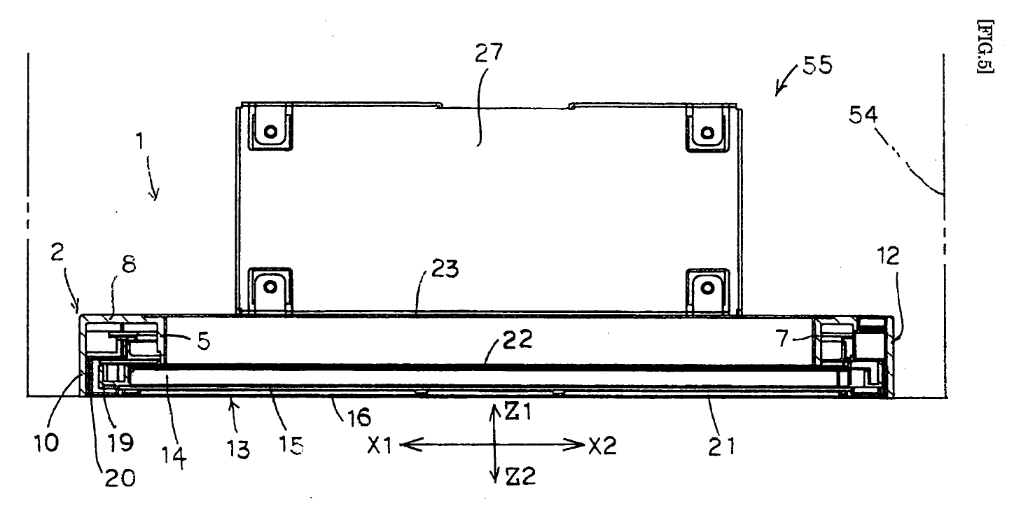

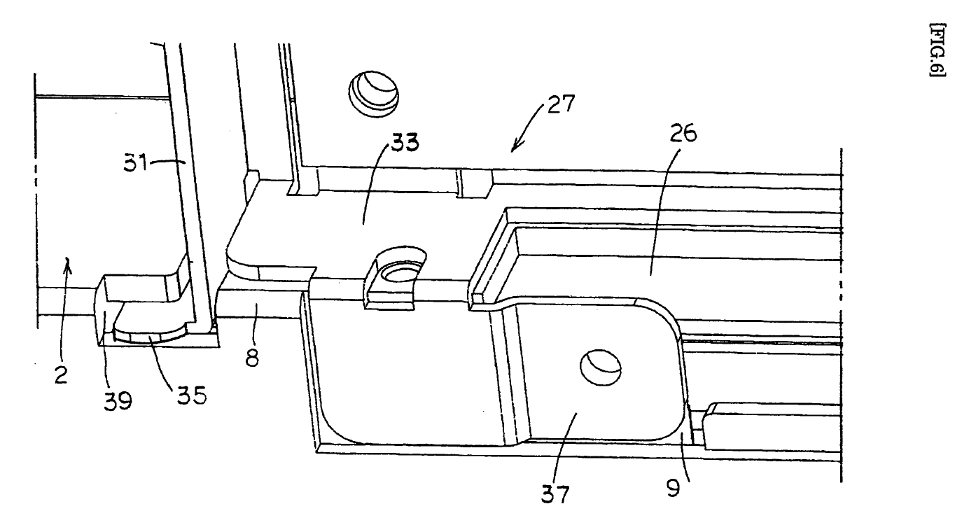

With reference to FIGS. 1 through 6, a liquid crystal display device 1 according to a preferred embodiment of the present invention will be described. FIG. 1 is a perspective view of a liquid crystal display device 1. FIG. 2 is a perspective view of the liquid crystal display device 1 when a cover is removed. FIG. 3 is an exploded perspective view of the liquid crystal display device 1. FIG. 4 is a sectional view along line A1-A2 in FIG. 1. FIG. 5 is a sectional view along line B1-B2 in FIG. 1. FIG. 6 is a detailed view of the portion C in FIG. 2.

A frame body 2, for example, is made of a plastic and coated in white. The frame body 2 has edge sections 4, 5, 6 and 7 formed around an opening 3.

The frame body 2 has a rear section 8 formed at a rear surface side Z1. The frame body 2 has four side sections 9, 10, 11 and 12 extending towards a front surface side Z2. As such, the frame body 2 is formed in a frame-like shape, including the side sections 9, 10, 11 and 12.

A liquid crystal display body 13 includes a light guide plate 14, a shutter 15, a liquid crystal panel 16, lamps 17 and 18, a resin frame 19, a front frame 20 and the like (see FIGS. 4 and 5). The light guide plate 14, for example, is made of an acrylic resin and the like, and formed in a rectangular parallelepiped.

The lamp 17, for example, is made of an elongated cold cathode fluorescent tube and the like, and disposed at a lower side (Y2 direction) of the light guide plate 14. The lamp 18, for example, is made of an elongated cold cathode fluorescent tube and the like, and disposed at an upper side (Y1 direction) of the light guide plate 14.

The shutter 15, for example, is made of a liquid crystal shutter and the like, and disposed towards a front surface side (Z2 direction) from the light guide plate 14. When a voltage is not applied to the shutter 15, the shutter 15 is closed and has a white hue.

The shutter 15 has a diffusion effect. When the shutter 15 is closed, light emitted from the lamps 17 and 18 enters the light guide plate 14 and proceeds to the front surface side (Z2 direction). As a result, the above light passes through the light guide plate 14 and the shutter 15, and illuminates the liquid crystal panel 16. At this time, the liquid crystal panel 16 performs a predetermined display. When the shutter 15 is opened, the shutter 15 becomes transparent.

As such, the liquid crystal panel 16 is disposed towards the front surface side (Z2 direction) from the shutter 15. The liquid crystal panel 16, for example, sandwiches a liquid crystal between an element substrate and a counter substrate. The element substrate is formed with a plurality of data lines extending in a longitudinal direction (Y1-Y2 direction) and a plurality of scanning lines extending in a transverse direction (X1-X2 direction). Corresponding to an intersection between each data line and each scanning line, a TFT which functions as a switching element is provided, respectively.

Each TFT's gate electrode is connected to the scanning line, source electrode is connected to the data line, and drain electrode is connected to a pixel electrode.

The counter substrate is provided with R, G and B color filters. A common electrode is provided by connecting to the color filters. A predetermined voltage is applied to the common electrode. The liquid crystal panel 16 is configured with the above components.

A resin frame 19, for example, is made of a plastic. The resin frame 19 is formed in a frame-like shape when viewed from the rear surface side (Z1 direction). A concave is formed at an upper side (Y1 direction) of the resin frame 19, and the lamp 18 is housed in the above concave. A concave is formed at a lower side (Y2 direction) of the resin frame 19, and the lamp 17 is housed in the above concave.

At the center of the resin frame 19 adjacent to the above concave, a stage is formed. The light guide plate 14, the shutter 15 and the liquid crystal panel 16 are sequentially deposited on the stage.

A front frame 20, for example, is made of a stainless plate and the like. It is formed substantially in an L-shape, when viewed in the sectional view of FIG. 5. The front frame 20 has an opening section 21 formed at the front surface side (Z2 direction).

A protrusion (not shown) formed at the side sections 10 and 12 of the frame body 2 is inserted into a hole (not shown) formed at the side section of the front frame 20. As a result, the front frame 20 is fixed to the frame body 2, at least supporting the liquid crystal panel 16.

Features of the above structure are outlined below. The liquid crystal display body 13 includes the light guide plate 14, the shutter 15 and the liquid crystal panel 16, sequentially disposed from the rear surface side (Z1 direction). The liquid crystal display body 13 also includes the resin frame 19 and the front frame 20.

The resin frame 19 supports the lamps 17 and 18, the light guide plate 14, the shutter 15 and the liquid crystal panel 16. The front frame 20 at least supports the liquid crystal panel 16, and is fixed to the frame body 2. As such, the liquid crystal display body 13 is fixed to the frame body 2 so as to be in internal contact with the frame body 2.

An elastic body 22, for example, is made of a rubber and the like, and formed in a frame-like shape when viewed from the front surface side (Z2 direction). The rear surface side (Z1 direction) of the elastic body 22 is disposed so as to abut to tips of the edge sections 5, 6, 7 and 8 formed at the frame body 2, respectively. The front surface side (Z2 direction) of the elastic body 22 is disposed so as to abut to the liquid crystal display body 13 (more particularly, to a surface of the light guide plate 14) (see FIG. 5).

A sheet 23, for example, is made of a transparent plastic, and fixed to a stage formed at the rear section 8 of the frame body 2, with an adhesive member such as a double-sided adhesive tape. As such, it is fixed to the rear section 8 of the frame body 2 so as to cover the opening 3 of the frame body 2.

A first circuit board 24 is fixed on a fixing plate 25. The first circuit board 24 and the fixing plate 25 are disposed between the side section 9 and the edge section 4 formed at the frame body 2.

A data-driving element (IC), for example, is disposed on the first circuit board 24. Each output terminal of the data-driving element is connected to the plurality of data lines provided at the liquid crystal panel 16 interposing a flexible substrate (not shown) therebetween.

As such, the first circuit board 24 is connected to the liquid crystal display body 13. An aperture 26 is formed at a part of the side section 9 and the rear section 8 of the front body 2 (see FIG. 3).

A support section 27, for example, is made of an iron plate and the like, and includes top surface sections 29 and 30, side sections 31 and 32, and placing surfaces 33 and 34 which are made by bending the raised section 28.

A clip 35 is a portion bent relative to the side section 31, and a clip 36 is a portion bent relative to the side section 32. As such, a pair of clips 35 and 36 is formed at the side sections 31 and 32 of the support plate 27.

A bent section 37 is a portion bent relative to the placing surface 33, and a bent section 38 is a portion bent relative to the placing surface 34.

At a proper position of the side section 9 of the frame body 2, a pair of recesses 39 and 40 is formed (see FIG. 3). The clip 35 of the support plate 27 is inserted into the recess 39 of the frame body 2. The clip 36 of the support plate 27 is inserted into the recess 40 of the frame body 2.

The edges of the clips 35 and 36 in the Y1 direction abut inner surfaces of the recesses 39 and 40. The position of the support plate 27 in a longitudinal direction (Y1-Y2 direction) to the frame body 2 is set by this. At this time, the bent sections 37 and 38 of the support plate 27 abut the side section 9 of the frame body 2, respectively.

A left side of the clip 35 abuts a left surface of the recess 39. A right side of the clip 36 abuts a right surface of the recess 40. The position of the support body 27 in a transverse direction (X1-X2 direction) to the frame body 2 is set by this.

The features of the above structure are outlined below. As the clips 35 and 36 are inserted into the recesses 39 and 40, respectively, the support plate 27 is positioned in the transverse direction and the longitudinal direction to the frame body 2.

At this time, a screw (not shown) is screwed into a hole 42 of the frame body 2, interposing a hole 41 of the support plate 27 therebetween. Another screw (not shown) is screwed into a hole 44 of the frame body 2, interposing a hole 43 of the support plate 27 therebetween.

According to the above structure, the support plate 27 is fixed to the frame body 2. As such, the support plate 27 is provided substantially orthogonal to the rear section 8 of the frame body 2.

A second circuit board 45 is fixed to the raised section 28 formed at the support plate 27 by four machine screws. Electrical components such as an external connection connector 46, connectors 47 and 48, and a timing controller (not shown) are disposed on the second circuit board 45.

A relay substrate 49 is made of a flexible substrate, for example. One side of the relay substrate 49 is fixed to the first circuit board 24, and a center section is positioned corresponding to the aperture 26. The other side is removably connected to the connector 47 provided at the second circuit board 45 (see FIG. 2).

Similarly, a relay substrate 50 is made of a flexible substrate, for example. One side of the relay substrate 50 is fixed to a third circuit board 51, and a center section is positioned corresponding to the aperture 26. The other side is removably connected to the connector 48 provided at the second circuit board 45.

As shown in FIG. 2, the third circuit board 51 is fixed on a fixing plate (not shown). The third circuit board 51 and the above fixing plate are disposed between the side section 10 and the edge section 5 formed at the frame body 2.

A scan-driving element (gate driver IC) is disposed on the third circuit board 51, for example. Each output terminal of the scan-driving element is connected to the plurality of scanning lines provided at the liquid crystal panel 16 interposing a flexible substrate (not shown), therebetween.

As shown in FIG. 1, a cover 52 includes a flat section 53 and three bent sections which lead to the flat section 53. The three bent sections abut internal surfaces of the top surface sections 28 and 29, and side sections 31 and 32 formed at the support plate 27, respectively.

Two screws are screwed to the holes at the bent section formed at a rear surface side (Z1 direction) of the cover 52, through the holes of the top surface sections 28 and 29. Another two screws are screwed to the holes formed at the bent sections 37 and 38 of the support plate 27, through the holes of the flat section 53. The liquid crystal display device 1 is formed with the above components.

A casing 54 is formed so as to house the liquid crystal display device 1. The liquid crystal display device 1 is screwed to the casing 54 by screws (not shown).

An applied product (such as a play device) 55 is configured with the casing 54, the liquid crystal display device 1, other components, and the like.

1. A liquid crystal display device, comprising:
a frame body in a frame-like shape having an edge section formed around an opening and having a side section;
a liquid crystal display body fixed to the frame body so as to be in internal contact with the frame body;
a first circuit board provided between the side section and the edge section, and connected to the liquid crystal display body;
a support plate provided substantially orthogonal to a rear section of the frame body; and
a second circuit board fixed to the support plate and connected to the first circuit board.

2. The liquid crystal display device according to claim 1, further comprising:
an elastic body formed in the frame-like shape having a rear surface side abutting a tip of the edge section and a front surface side abutting the liquid crystal display body, and
a sheet fixed to the rear section of the frame body so as to cover the opening.

3. The liquid crystal display device according to claim 1,
wherein the frame body is provided with a pair of recesses to the side section thereof,
the support plate is provided with a pair of clips to the side section thereof; and
the support plate is positioned in a transverse direction and a longitudinal direction to the frame body, by inserting the clips to the respective recesses.

4. The liquid crystal display device according to claim 1, wherein the frame body is provided with an aperture to the side section and the rear section thereof, and one side is fixed to the first circuit board, a middle section is positioned corresponding to the aperture, and the other side is removably connected to a connector provided at the second circuit board.

5. The liquid crystal display device according to claim 3, wherein
the support plate includes a placing surface and a bent section;
the placing surface abuts the rear section of the frame body;
the bent section abuts the side section of the frame body; and
the placing surface is fixed to the rear section by a screw.
